(19) United States
(12) Patent Application Publication
(10) Pub. No.: US 2015/0296063 A1
(43) Pub. Date: Oct. 15, 2015

(54) ELECTRONIC DEVICE

(71) Applicant: Flexenable Limited, Cambridge, Cambridgeshire (GB)

(72) Inventor: William Reeves, Willingham, Cambridgeshire (GB)

(21) Appl. No.: 14/423,389

(22) PCT Filed: Aug. 29, 2013
(86) PCT No.: PCT/GB2013/052260

§ 371 Date: Feb. 23, 2015

(30) Foreign Application Priority Data
Aug. 30, 2012 (GB) 1215394.6

(51) Int. Cl. H04M 1/02; G06F 1/16

(52) U.S. Cl. CPC H04M 1/0268; G06F 1/1652

(57) ABSTRACT

We describe an electronic device including a display screen and having a housing, the housing having a front, display surface, wherein the display is a flexible display, and wherein the flexible display is bent at an angle to said display surface. In embodiments the flexible display comprises a flexible substrate bearing a display medium and interface electronics along one edge, and wherein said flexible display is bent such that a display portion of said display medium corresponds with said display surface and wherein said interface electronics are located in or beyond a bent region of said flexible display.

### FIELD OF THE INVENTION

This invention relates to displays in particular flexible displays for mobile electronic devices;

### BACKGROUND TO THE INVENTION

Increasingly, mobile electronic devices such as smartphones are used to view, create and edit documents or images. It is desirable to increase the usable area of the display screen of an electronic device.

### SUMMARY OF THE INVENTION

According to a first aspect of the invention, there is provided an electronic device including a display screen and having a housing, the housing having a front, display surface, wherein the display is a flexible display, and wherein the flexible display is bent at an angle to the display surface.

In embodiments the flexible display comprises a flexible substrate bearing a display medium and interface electronics along one edge, and wherein the flexible display is bent such that a display portion of the display medium corresponds with the display surface and wherein the interface electronics are located in or beyond a bent region of the flexible display.

Preferably the flexible display is bent around an internal edge of the housing such that the interface electronics lie along the internal edge. In embodiments the front, display surface comprises a transparent cover and wherein the display medium abuts the transparent cover. In embodiments the flexible display comprises a display backplane on a flexible substrate; and wherein the display medium is mounted on the display backplane. In embodiments the display backplane comprises an array of organic active matrix pixel driver circuitry on a plastic substrate, wherein the plastic substrate extends beyond a border of the display, and wherein at least a portion of the display interface electronics is fabricated on the plastic substrate.

Preferably the plastic substrate extends beyond the border of the display on at least a side where the flexible display is bent, wherein the display interface electronics includes a plurality of pixel driver chips mounted in or beyond the bent region the plastic substrate, and further comprising two sets of tracks on the plastic substrate between the pixel driver chips and the display, one running along one or each of two adjacent sides of the flexible display to the bent side of the flexible display.

The invention also provides a method of manufacturing an electronic device, the method comprising: providing an active matrix display backplane on a plastic substrate; mounting a display on the display backplane; providing a housing for the electronic device; bending the display backplane around the inside of the housing to increase a proportion of display area of the electronic device.

In embodiments the method comprises providing a front window for the display; providing a side/rear housing for the device; and the bending comprises bending the display around a side wall of the housing.

Other Display Arrangements

In the following description the feature of the display being detachable is optional. In the following arrangements the display may be bent around the inside of the housing, in particular as described above.

We also describe a detachable flexible display device comprising: at least one electronic paper display screen; optional attachment means to attach the display device to a mobile electronic device; and interfacing means to enable the device to communicate with the mobile electronic device.

Broadly speaking, the invention provides a user of a mobile electronic device, such as mobile phone, with a larger additional and detachable display to allow the user to view and manipulate documents. The mobile electronic device may be, for example, a PDA (personal digital assistant), a mobile phone (in particular, a smartphone) or other such devices.

The flexible display device may be attached to a mobile electronic device when required or may also be attached to the mobile device when the mobile device is not in use. When attached to the mobile device, the display device can be wrapped around the mobile device when the phone is not being used, and can be unwrapped when required to view documents. Alternatively, the flexible display device can be detached from the mobile phone and used as a standalone display, as described below.

In a preferred embodiment, the electronic paper display is an electrophoretic display, electro-wetting display or electrofluidic display screen. These displays are reflective display mediums. Electrofluidic displays enable improved brightness/contrast as well as high resolution screens and near video display update rates. Where an electrofluidic display is employed, for example of the type available from Gamma Dynamics, Inc. Ohio USA, the, colour filter array may be omitted. The use of an electrofluidic display facilitates improved brightness/contrast as well as near video display update rates and high resolution, in embodiments of order 225 pixels per inch. Electrophoretic displays are an example of reflective display mediums, which allow the display device to be used in bright light conditions, such as outdoors. A colour display may be provided by providing a colour filter array over the electrophoretic display medium.

In a preferred embodiment, the attachment means of the detachable flexible display device comprises a magnetic strip along an edge of the display device. The magnetic strip may be physically adhered to the top of the display device. Preferably, the magnetic strip is incorporated within the thickness of the display device. The magnetic strip enables the display device to magnetically attach to a mobile electronic device that contains magnetic components.

In a preferred embodiment, the interfacing means of the detachable flexible display device comprises a wireless connection means for communication with a mobile electronic device. The wireless connection means includes electronics for a wireless link to a mobile device. The wireless link may be, for example, WiFi or Bluetooth™. In the case of a Bluetooth link, the wireless connection means includes a Bluetooth™ RF chip and antenna. The wireless link enables programs, data and documents to be transmitted from a mobile electronic device to the display device for display and editing, and for edited data and documents to be transmitted back to the mobile device. The wireless connection advantageously enables the display device to be used in combination with any mobile electronic device that has wireless capability, and circumvents the use of mobile device-specific physical connections between the display device and mobile device. As described above, this also enables the flexible display device to communicate with a mobile device when it is being operated in a standalone configuration (i.e. when it is not physically attached to the mobile device).

In a preferred embodiment, the wireless connection means enables automatic synchronisation and transfer of data between the display device and a mobile electronic device. This allows for example, document edits performed using the display device to be transferred to the mobile device automatically, providing a user with an efficient way to save documents.

In another preferred embodiment, the interfacing means of the detachable flexible display device comprises a wired connection means for communication with a mobile electronic device. The wired connection means may be for example, a USB or other docking connector. As described above, the wired connection enables programs and data to be transmitted and received between the flexible display device and the mobile electronic device. The wired connection means includes a USB to serial interface chip and other electronics to enable the interfacing.

In a preferred embodiment, the detachable flexible display device comprises a microprocessor and a user interface to enable the device to enable standalone operation when not interfaced with the mobile electronic device. As mentioned above, the flexible display device can be used when the display device is not attached or wirelessly connected to the mobile device. Software to drive the display may be located on the flexible display device and the mobile electronic device. The display device comprises a memory and a rechargeable battery such that documents can be stored in the display device for viewing or editing. The display device user interface allows a user to edit and save documents, which can be automatically transferred to a mobile device once the mobile device is wirelessly connected to the display device. In embodiments, the display device may comprise physical buttons located for example, along an edge of the display device, which enable the user to control the user interface.

The wired embodiment of the display device, as described above, may not include a rechargeable battery. In the wired embodiment, the display device is powered via the USB connection to the mobile electronic device and software to drive the display may be located on the mobile electronic device.

In a preferred embodiment, the flexible display device further comprises a display backplane comprising organic active matrix pixel driver circuitry on a plastic substrate, and display interface electronics for said active matrix pixel driver circuitry; wherein said electronic paper display is mounted on said display backplane, wherein said plastic substrate extends beyond a border of said electronic paper display; and wherein at least a portion of said display interface electronics is fabricated on said plastic substrate in a said stiffened region of said display device.

In a preferred embodiment, the attachment means comprises a wireless dock device to physically hold said mobile electronic device. A mobile electronic device may slot into or sit within a recess in the display device which forms a dock device. The dock device does not comprise any electrical or physical connections to enable the mobile device to connect with the display device; rather, the mobile device connects wirelessly to the display device as described above.

In a preferred embodiment, the dock device comprises a rear panel and is physically configured to fit in around or against said mobile electronic device, wherein said electronic paper display is attached along one edge to said dock device, and wherein said dock device incorporates at least a portion of control electronics for said electronic paper display. In this embodiment, the electronic paper display screen is physically attached along an edge of the dock device, such that when a mobile device is docked, the display screen is adjacent to the mobile device. When the display screen is folded into the wrapped state, the display screen and the rear panel of the dock device may provide the mobile device protection against impact.

In a preferred embodiment, the flexible display device comprises: a flexible plastic substrate; an array of organic thin film transistors (TFTs) on said substrate; a layer comprising conductive tracks for addressing said array; a layer of electronic paper display medium over said array of organic TFTs; a front window over said electronic paper display medium; a layer of touch sensing tracks between said front window and said display medium; and further comprising a stripe of magnetic material mounted on a said substrate along an edge of said display, in particular within a thickness of the device.

In a preferred embodiment, the organic TFTs are mounted on a display backplane on said flexible plastic substrate; and the flexible display device further comprises: display interface electronics for said display, coupled to said display backplane; wherein said flexible plastic substrate extends beyond a border of said display; and wherein at least a portion of said display interface electronics is fabricated on said flexible plastic substrate.

The above described aspects and embodiments of the invention may be combined in any permutation.

### BRIEF DESCRIPTION OF THE DRAWINGS

The invention is diagrammatically illustrated, by way of example, in the accompanying drawings, in which:

FIG. 1 shows an electronic device incorporating a flexible display according to an embodiment of the invention;

FIG. 2 shows schematically, connections to display interface electronics for the device at FIG. 1;

FIG. 3 shows a detailed vertical cross-section view through an embodiment of the flexible display;

FIG. 4 shows a block diagram of display driver circuitry for a display module;

FIG. 5 shows a front window for the display of FIG. 3, incorporating a touch-sensor;

FIG. 6 shows a colour filter array for the display of FIG. 3;

FIG. 7 shows a display media layer for the display of FIG. 3; and

FIG. 8 shows a substrate/backplane layer for the display of FIG. 3 mounting display interface electronics.

### DETAILED DESCRIPTION OF PREFERRED EMBODIMENTS

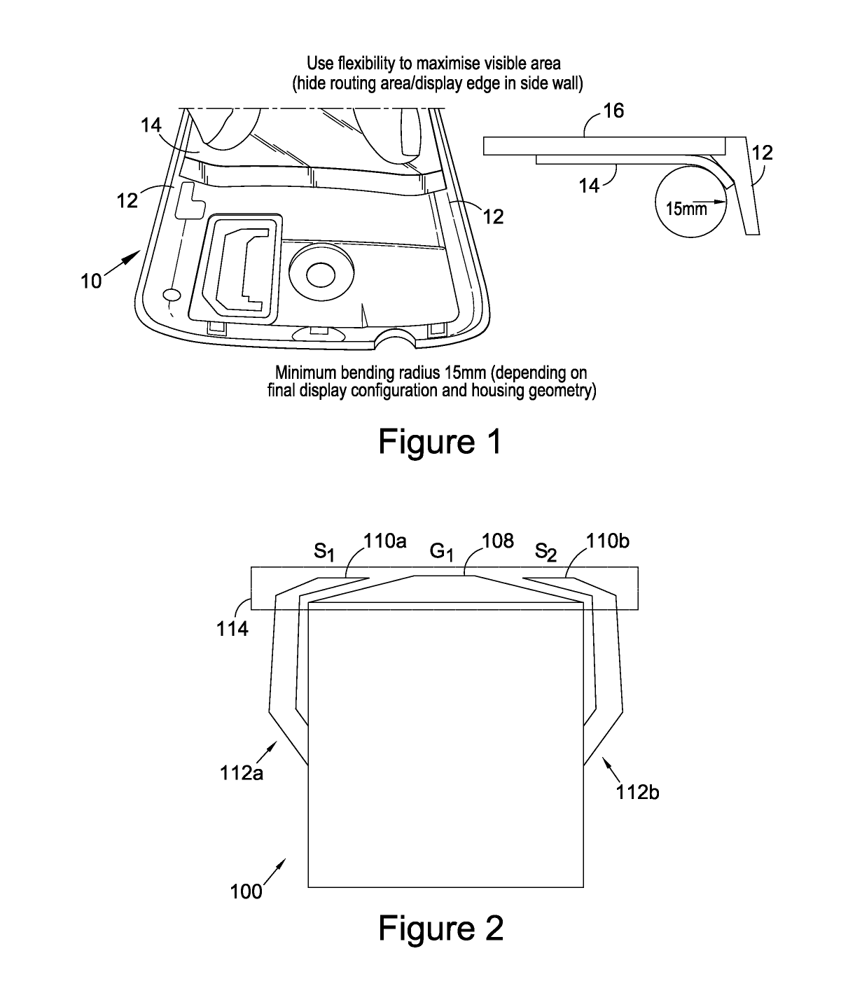

FIG. 1 shows a preferred embodiment of an electronic device 10 incorporating a flexible display.

Embodiments of the device may be used with electronic devices including, but not limited to: a laptop or desktop computer, a PDA (personal digital assistant), a mobile phone or smartphone, or the like. Embodiments of the device may also be configured to enable it to be used as a second screen or the primary screen of the ‘host’ electronic device.

In embodiments the display gives the appearance of paper. Optionally the device may be configured so that it appears to the host device as a conventional, paper-based printer—for example enabling a document to be displayed on the device by opening the document and clicking print. This can be achieved by providing an appropriate printer driver for the host device (for example as described in our WO2009/053738) and providing corresponding software on the document reading device. In embodiments the display may be borderless, to enhance the impression of ‘electronic paper’. Alternatively the display may have the appearance of being borderless by cropping the margins of an image to be displayed and then arranging for the border of the electronic reading device to give the appearance of the margins so that, when displayed, the document page appears, to a viewer, to extend substantially to the edges of the device. Thus in embodiments the borders of the device are coloured to match a white paper background. Where borders are present they may be for example of width around 1 cm and extend to all the edges of the device (optionally excluding the handle part) and internal colouring is employed at a corresponding depth within the device to the active display media to reduce any visual discontinuity at the boundary of the active display region.

Referring now in more detail to FIG. 1, an embodiment of the invention is shown with a flexible display screen 14 arranged within an electronic device 10. The flexible display screen 14 is configured to bend in order to fit within the electronic device 10. In the embodiment shown here, the edges of the display screen 14 bend such that they conform to the moulding of the electronic device side walls 12. As described above, one or more edges of the display screen may comprise interface electronics. The bent edges of the display screen may thus enable the interface electronics to be located along the edges of the electronic device 10. As shown in the diagram on the right hand side of FIG. 1, an edge of the display screen 14 may be bent to conform to the curvature of the housing side wall 10. The display area of the electronic device 10 can be maximised by bending the electronics of the display screen 14 away from the display area as defined by the area of the cover glass 16 and out of view. An advantage of this approach is thus to maximise the display area of an electronic device without significantly altering the dimensions of the device. In embodiments, the minimum bending radius is 15 mm, depending on the final display configuration and housing geometry of the electronic device 10.

In embodiments the display interface electronics includes a plurality of pixel driver chips, which are mounted in the bent region, preferably on an extension of the plastic substrate. In embodiments these include at least one gate driver chip and at least two source/drain driver chips, one of the source/drain driver chips driving a set of data lines extending from each edge of the display (in a direction generally parallel to the handle). In embodiments of the device which include a touch sensitive screen, for example a projected capacitance touch sensitive screen, a similar technique may be employed to connect to either end of the line of a touch sensing track. This is because the indium tin oxide (ITO) tracks are relatively resistive and thus by connecting to either end of the track line, with an electrical break in the middle of the track, and providing a separate touch sensing chip for each end of the track, finer lines and hence more accurate touch sensing may be implemented on larger area displays.

In preferred embodiments the lateral extension of the plastic substrate beyond the display edge is concealed by a border of the electronic reading device, which may comprise an opaque region around the border of the display behind the transparent front protective layer (except where a handle is located).

In other embodiments the tracks to the display drive electrodes around the edges of the display may be run behind the display area and the display may be substantially borderless.

FIG. 2 shows an internal arrangement of the display interface electronics, which are arranged within region 104. This includes display driver integrated circuits for the display, which may be an electrophoretic display or electrofluidic display. As illustrated in FIG. 2 the display interface electronics comprises a gate driver integrated circuit 108 and first and second source driver integrated circuits 110a, b. In embodiments the source lines of the display are driven from opposite edges of the display and the gate lines are driven from the handle edge of the display, and thus connections 112a, b between the source driver lines of the display backplane and the source driver integrated circuits 110a, b run along edges of the display portion 102, concealed under a thin border. Other electronics optionally associated with the display may also be located within region 104—which may be very thin.

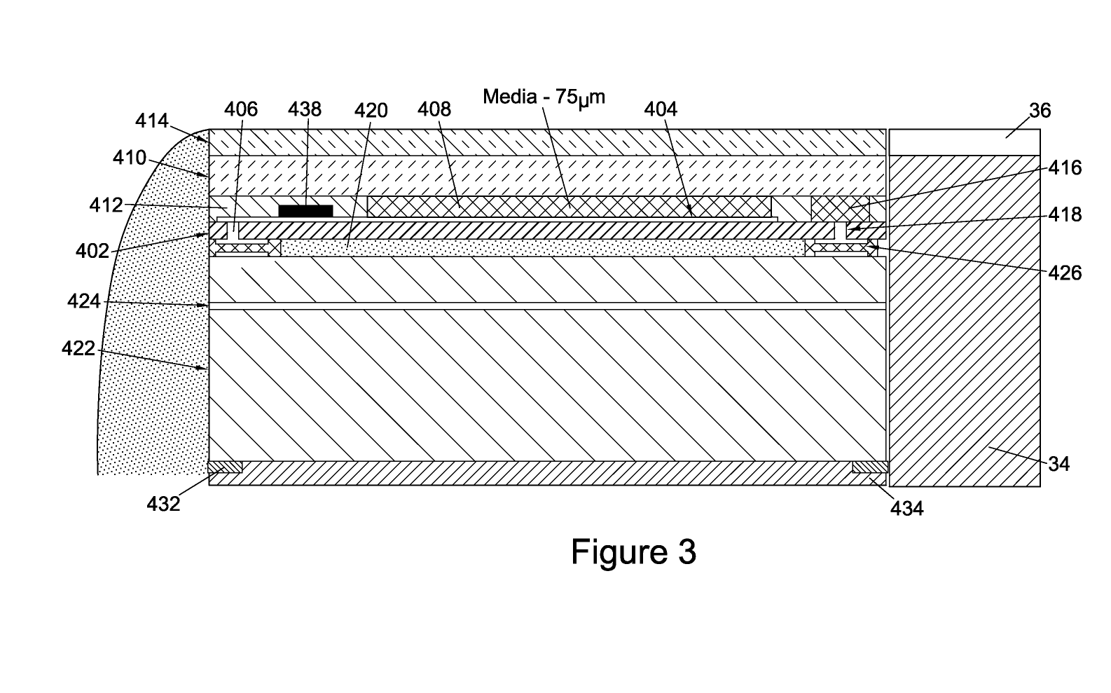

FIG. 3 shows a vertical cross-section view through an embodiment of the flexible display device, in which electronic components of the device are located along an edge of the device on a flexible PCB. A display medium 408 is attached to substrate 402, for example by adhesive.

In more detail, the structure comprises a substrate 402, typically a plastic such as PET (polyethyleneterephthalate) or pen(polyethelenemaphthalene) on which is fabricated a thin layer of organic active matrix pixel circuitry. The circuitry may comprise an array of organic (or inorganic) thin film transistors for example as previously described in our WO01/47045, WO2004/070466, WO01/47043, WO2006/059162, WO2006/056808, WO2006/061658, WO2006/106365 and WO2007/029028. Broadly speaking in embodiments the backplane is fabricated using solution based techniques patterned by, for example, direct-right printing, laser ablation or photolithography to fabricate the thin film transistors. In embodiments the active devices have a thickness of order 5-10 μm. In embodiments this layer has a thickness of order 50 μm and has integrated encapsulation. This substrate/backplane layer bears row and column data lines and address conductive tracks, connected to the rear of substrate 402 by vias. We here refer to front as being towards the display surface of the device and rear as being towards the rear of the device.

A display medium 408 is attached to substrate 402, for example by adhesive. In preferred embodiments the display medium is a reflective display medium (which facilitates daylight reading), for example an electrophoretic display medium or an electrofluidic display medium. Where an electrophoretic display medium is employed a colour display may be provided by providing a colour filter array 410 over the display medium; optionally this may also perform an encapsulation function. Additionally or alternatively a moisture barrier may be provided over the display, for example comprising polyethylene and/or Aclar™ (a fluropolymer, polychlorotrifluoroethylene-PCTFE). In some embodiments the thickness of the display medium is of order 75 μm and that of the encapsulation/colour filter array of order 120 μm.

Where an electrofluidic display is employed, for example of the type available from Gamma Dynamics, Inc. Ohio USA, the colour filter array may be omitted. The use of an electrofluidic display facilitates improved brightness/contrast as well as near video display update rates and high resolution, in embodiments of order 225 pixels per inch.

In embodiments whichever display medium is employed, an edge seal is provided to seal the edge of display medium to the edge of the display module.

As described above, the display medium is a reflective display medium (which facilitates daylight reading), in particular an electronic paper display medium, for example an electrophoretic display medium or an electrofluidic display medium.

A front window 414 is provided over the display, for example comprising a thin layer of PMMA (polymethylmethacrylate). Where the device is touch sensitive, this layer may also include conductive row and column lines for the touch circuitry. The touch sensing circuitry may be operable by finger and/or a stylus. A connection to the touch sensing layer may be made by a Z-axis conductive pad 416 which connects to the touch electrodes in window 414 through CFA/encapsulation layer 410 (for example by vias, not shown) and vias 418 through substrate 402 bring the touch array connections to contact pads on the rear of substrate 402.

An adhesive layer 420 connects the substrate 402 to a flexible PCB 422 (which may incorporate circuitry 424 for an inductive stylus sensor. Connections between the contact pads on the rear of substrate 402 and the flexible PCB employ an anisotropic conductive film (ACF) 426. The illustrated structure facilitates the omission of a separate moisture barrier under substrate 402, although such a barrier may be incorporated if desired.

A flexible PCB 34 carries electronic components, for example surface mounted components, and a thin film flexible polymer battery. Flexible PCB 34 also bears a conductive loop 432 around the border of the device for inductive charging of battery 430. A storage device may also be carried on the flexible PCB. A thin back cover 434 may be used to provide a protective layer as described above, which may protect against impact or be waterproof. Optionally a magnetic strip 36 may be mounted along an edge of the substrate.

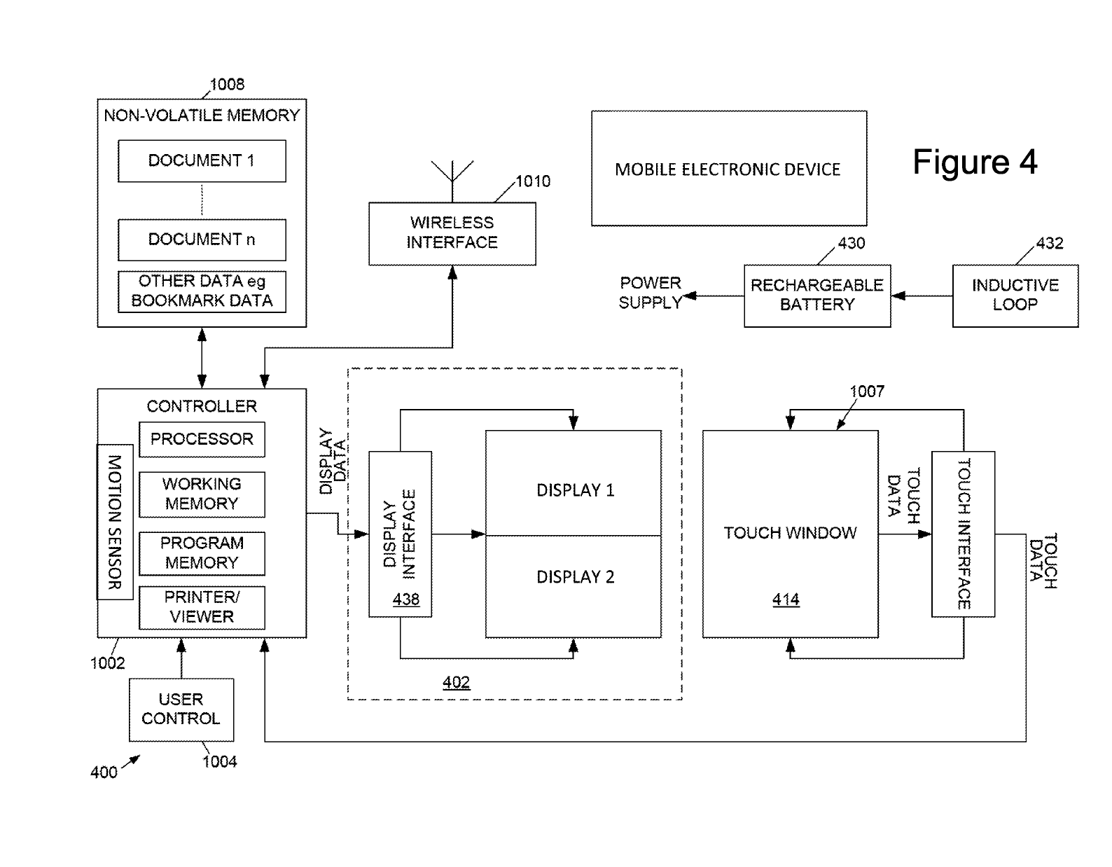

FIG. 4 shows a block diagram of the electronics for a display module which be provided to simplify interfacing with the display device. For example these may be used to provide a self-contained, removable display. However the electronics of FIG. 4 are entirely optional.

The device comprises a controller 1002 which includes a processor, for example an ARM™ device, working memory and program memory coupled to one or more display interface integrated circuits 438 for driving the electronic paper display 408. One or more touch interface integrated circuits 1006 interface with the touch electrodes on front window 414 to provide touch data to controller 1002. The controller also includes a motion sensor which is capable of detecting when the display device is rotated, as described above. Operation of the controller is further described below with reference to FIG. 6.

In a wired embodiment of the display device, in which the display device connects to the mobile electronic display via a wired connection, the display device may not comprise a rechargeable battery 430 and inductive loop 432. In this case, the display device is powered via the USB connection.

The program memory in embodiments stores processor control code to implement functions including an operating system, various types of wireless and wired interface, document retrieval, storage, annotation (via the touch interface) and export from the device. The stored code also includes code 1003 to implement a document viewer/‘printerless printing’ function, for example interfacing with corresponding driver code on a ‘host’ device.

The controller 1002 interfaces with non-volatile memory, for example Flash memory, for storing one or more documents for display and, optionally, other data such as user bookmark locations and the like. Optionally a mechanical user control 1004 may also be provided.

A wireless interface 1010, for example a Bluetooth™ or WiFi interface is provided for interfacing with a mobile electronic device. For example, the wireless interface can be used by the display device to receive image data from the mobile electronic device and transmit touch data back to the mobile device. The wireless interface 1010 may comprise a Bluetooth™ chip and antenna.

As previously mentioned inductive loop 432 is used to charge the rechargeable battery 430 which has associated circuitry for providing a regulated power supply to the system.

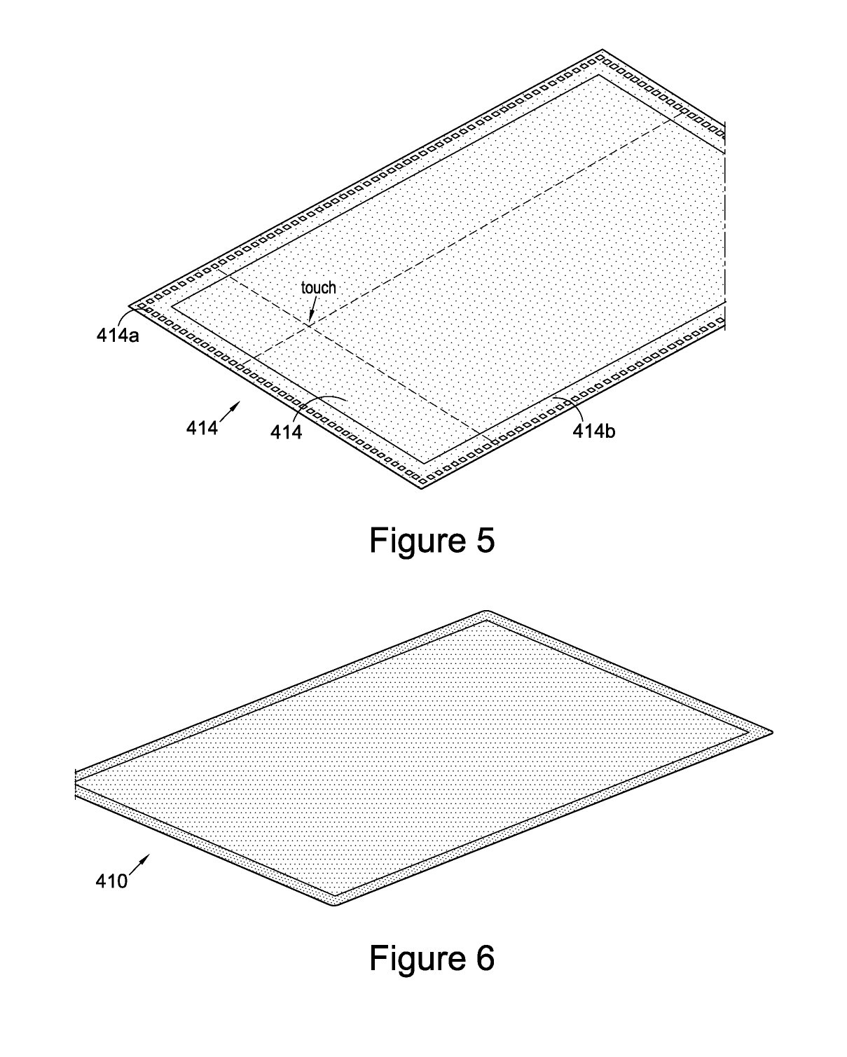

Referring next to FIGS. 5 to 8, these show perspective views of layers illustrated in the cross-section of FIG. 4. Thus FIG. 5 shows plastic front window 414 which protects the display medium and, where present, the colour filter array. This window has a plurality of pads 414a around the edge which connect to tracks on the touch sensor FLM (fine line metal) in the case of a capacitive sensor. In embodiments the fine line metal has a width in the range 2-5 μm. The window 414 provides a narrow border 414b around the active display area.

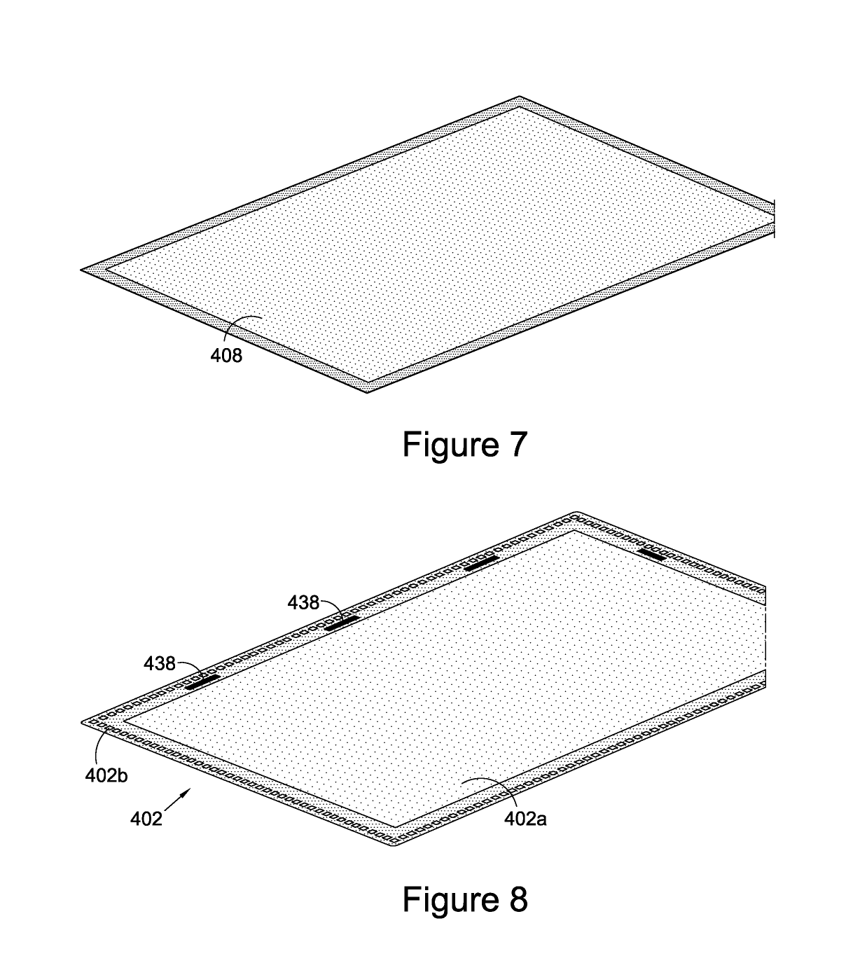

FIG. 6 shows a plan view of the colour filter array 410, again with a narrow border. In embodiments this may provide a regular pattern of red, green, blue and white colours. FIG. 7 shows the display medium 408, with the active area of the media substantially following the entire available area. FIG. 8 shows substrate 402 having an active backplane area 402a for driving pixels of the display medium 408. Substrate 402 is provided with pads 402b around the edge to carry touch signals between the touch electrodes of window 414 and touch sensing circuitry on PCB 422. Substrate 402 also bears a plurality of display driver integrated circuits 438, mounted on substrate 402 using chip-on-plastic technology. Connections to these when made, for example, by other pads (now shown).

No doubt many other effective alternatives will occur to the skilled person. It will be understood that the invention is not limited to the described embodiments and encompasses modifications apparent to those skilled in the art lying within the spirit and scope of the claims appended hereto.

1. An electronic device, the device including a display screen and having a housing, the housing having a front, display surface, wherein the display is a flexible display, and wherein the flexible display is bent at an angle to said display surface.

2. An electronic device as claimed in claim 1 wherein the flexible display comprises a flexible substrate bearing a display medium and interface electronics along one edge, and wherein said flexible display is bent such that a display portion of said display medium corresponds with said display surface and wherein said interface electronics are located in or beyond a bent region of said flexible display.

3. An electronic device as claimed in claim 2 wherein said flexible display is bent around an internal edge of said housing such that said interface electronics lie along said internal edge.

4. An electronic device in claim 1 wherein said front, display surface comprises a transparent cover and wherein said display medium abuts said transparent cover.

5. An electronic device as claimed in claim 1 wherein said flexible display comprises a display backplane on a flexible substrate; and wherein said display medium is mounted on said display backplane.

6. An electronic device as claimed in claim 5 wherein said display backplane comprises an array of organic active matrix pixel driver circuitry on a plastic substrate, wherein said plastic substrate extends beyond a border of said display, and wherein at least a portion of said display interface electronics is fabricated on said plastic substrate.

7. An electronic device as claimed in claim 2 wherein said plastic substrate extends beyond said border of said display on at least a side where said flexible display is bent, wherein said display interface electronics includes a plurality of pixel driver chips mounted in or beyond said bent region said plastic substrate, and further comprising two sets of tracks on said plastic substrate between said pixel driver chips and said display, one running along one or each of two adjacent sides of said flexible display to said bent side of said flexible display.

8. A method of manufacturing an electronic device, the method comprising:
providing an active matrix display backplane on a plastic substrate;
mounting a display on said display backplane;
providing a housing for said electronic device;
bending said display backplane around the inside of said housing to increase a proportion of display area of said electronic device.

9. A method as claimed in claim 8 comprising
providing a front window for said display;
providing a side/rear housing for said device; and
wherein said bending comprises bending said display around a side wall of said housing.

10. (canceled)
